(19) United States
(12) Patent Application Publication
(10) Pub. No.: US 2021/0061288 A1
(43) Pub. Date: Mar. 4, 2021

(54) DRIVER DRIVING STYLE DETECTION AND APPLICATION SYSTEM

(71) Applicant: Toyota Motor North America, Inc., Plano, TX (US)

(72) Inventor: Aniket K. SAMEL, Dallas, TX (US)

(21) Appl. No.: 16/554,361

(22) Filed: Aug. 28, 2019

(51) Int. Cl. B60W 40/09; G05D 1/00; G05D 1/02

(52) U.S. Cl. CPC B60W 40/09; G05D 1/0061; B60W 2540/30; G05D 1/0221; B60W 2540/28; G05D 1/0088

(57) ABSTRACT

Methods, systems, and apparatus for automatically detecting and applying a driving style of a driver. The system includes one or more vehicle sensors configured to detect sensor data associated with the driver operating a vehicle in a non-autonomous mode. The system also includes an electronic control unit (ECU) of the vehicle connected to the one or more vehicle sensors and configured to operate the vehicle in an autonomous mode based on driver driving style data determined based on the detected sensor data, such that the vehicle is operated in the autonomous mode in a manner resembling the driving style of the driver.

### BACKGROUND

### 1. Field

This specification relates to a system and a method for automatically determining and implementing a driving style to be used by a vehicle in autonomous driving.

### 2. Description of the Related Art

A vehicle may be driven manually (i.e., non-autonomously) by a driver. The driver may operate the vehicle in a manner that is particular to the driver. For example, a first driver may accelerate slowly, brake gently, and turn relatively slowly. The first driver may do this because the driver is comfortable with this style of driving. A second driver, for example, may accelerate aggressively, change lanes frequently on the freeway, and brake suddenly. If the first driver were to be driven by the second driver, the first driver may be uncomfortable. Likewise, if the second driver were to be driven by the first driver, the second driver may also be uncomfortable.

Autonomous vehicles are designed to operate in the manner instructed by the designers of the autonomous vehicle. Accordingly, for many individuals, the autonomous vehicle may operate in a manner that is unlike how they operate a vehicle. Thus, there is a need for improved autonomous vehicle operation.

### SUMMARY

What is described is a system for automatically detecting and applying a driving style of a driver. The system includes one or more vehicle sensors configured to detect sensor data associated with the driver operating a vehicle in a non-autonomous mode. The system also includes an electronic control unit (ECU) of the vehicle connected to the one or more vehicle sensors and configured to operate the vehicle in an autonomous mode based on driver driving style data determined based on the detected sensor data, such that the vehicle is operated in the autonomous mode in a manner resembling the driving style of the driver.

Also described is a system for automatically detecting and applying a driving style of a driver. The system includes one or more vehicle sensors of a first vehicle configured to detect sensor data associated with the driver operating the first vehicle in a non-autonomous mode. The system also includes an electronic control unit (ECU) of a second vehicle configured to operate the second vehicle in an autonomous mode based on driver driving style data determined based on the detected sensor data, such that the second vehicle is operated in the autonomous mode in a manner resembling the driving style of the driver operating the first vehicle.

Also described is a method for automatically detecting and applying a driving style of a driver. The method includes detecting, by one or more vehicle sensors, sensor data associated with the driver operating a vehicle in a non-autonomous mode. The method also includes determining driver driving style data based on the sensor data. The method also includes operating, by an electronic control unit (ECU), the vehicle in an autonomous mode based on the driver driving style data, such that the vehicle is operated in the autonomous mode in a manner resembling the driving style of the driver.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIGS. 1A-1C illustrate detection of a driver driving style, according to various embodiments of the invention.

FIGS. 2A-2C illustrate application of the detected driver driving style in autonomous driving, according to various embodiments of the invention.

FIG. 3 illustrates a block diagram of the system, according to various embodiments of the invention.

FIG. 4 illustrates a process of the system, according to various embodiments of the invention.

### DETAILED DESCRIPTION

Disclosed herein are systems, vehicles, and methods for detecting a driver driving style and applying the driver driving style to an autonomous vehicle. The systems and methods described herein use vehicle sensors to detect sensor data when the driver operates a vehicle non-autonomously, and determines a driver driving style based on the detected sensor data. The driver driving style is then used by an autonomous vehicle that the driver is an occupant of. In this way, the autonomous vehicle will behave in a way that is predictable and comfortable for the driver.

Conventional autonomous vehicles are incapable of reflecting the driving style of the occupants of the vehicle, which may act as a deterrent for some drivers. The systems, vehicles, and methods disclosed herein may promote use of autonomous driving technology, as the way the autonomous vehicle is operated will be familiar to the driver. The drivers may also feel that their unique driving style is not lost due to utilization of an autonomous vehicle. In aggregate, use of autonomous vehicles may increase, thus increasing vehicle safety.

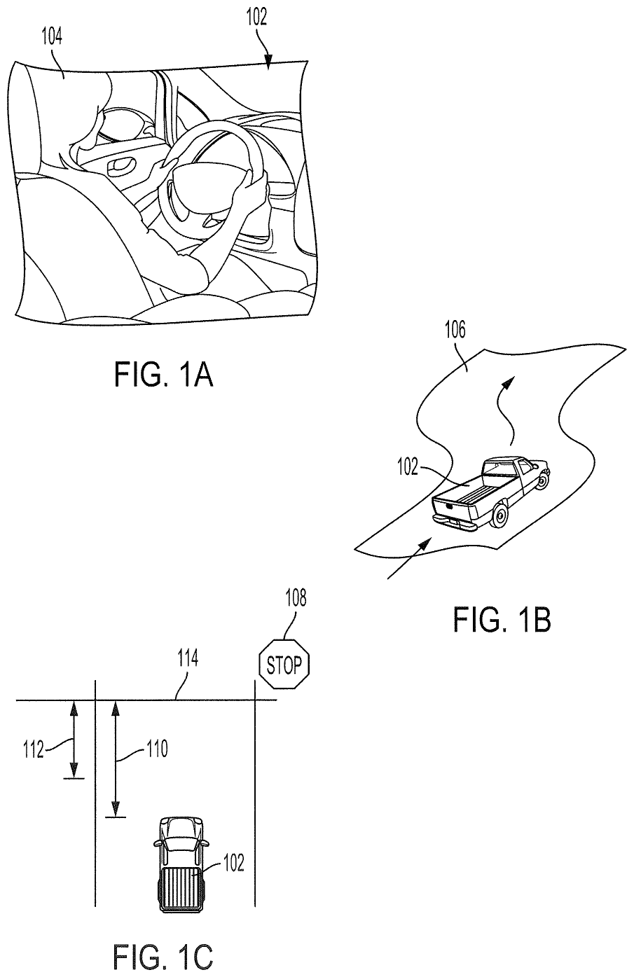

FIGS. 1A-1C illustrate detection of a driver driving style. A driver 104 is driving a vehicle 102. The vehicle 102 may be capable of being operated in a non-autonomous mode, whereby the driver 104 controls the operations of the vehicle 102, including, but not limited to, the steering of the vehicle 102, the acceleration of the vehicle 102, the braking of the vehicle 102, and control of the transmission of the vehicle 102.

Each human driver may have various driving habits or tendencies, which are referred to herein as the driver's style. The driver's style may be defined by various habits, such as acceleration habits, braking habits, steering habits, and transmission habits. The driver's style may also be dependent on various factors, such as time of day, day of the week, location, weather, or type of vehicle.

FIG. 1B illustrates the driver 104 driving the vehicle 102 in a curved road 106. The steering habits of the driver 104 in the curved road 106 may be aggressive, as is the acceleration habits of the driver 104. Further, when the time of day is during the daytime, the driver 104 may be more aggressive, and when the time of day is during the nighttime, the driver 104 may be less aggressive. When the curved road 106 is near the edge of an elevated location, such as a mountain road or an elevated coastal road, the driver 104 may be less aggressive.

Other drivers may have less aggressive steering habits and acceleration habits when traversing the curved road 106. A slower approach to steering and acceleration through the curved road 106 may be less exciting, but may be calmer and may result in the driver and occupants feeling safer. Whether a driver traverses the curved road 106 in an aggressive manner or a slower manner may be a matter of personal preference.

FIG. 1C illustrates the driver 104 driving the vehicle 102 as the vehicle 102 approaches a stop sign 108. The driver 104 may begin applying the brakes when the vehicle 102 is a first distance 110 away from the stop line 114. By applying the brakes when the vehicle 102 is the first distance 110 away from the stop line 114, the vehicle 102 may come to a slow, smooth stop.

Other drivers may apply the brakes when the vehicle 102 is a second distance 112 away from the stop line 114, resulting in a faster, sharper stop. Applying the brakes at the first distance 110 may result in a more comfortable experience, but applying the brakes at the second distance 112 may result in a faster time past the stop sign 108. Whether a driver applies the brakes at the first distance 110 or the second distance 112 may be a matter of personal preference.

The vehicle 102 may use one or more vehicle sensors to detect sensor data when the driver 104 drives the vehicle 102 in a non-autonomous mode. The vehicle 102 may then determine the driver's style based on the detected sensor data. As described herein, the driver's style may vary based on location, time of day, or number of occupants, for example. In some embodiments, a threshold sample size of sensor data is exceeded before a driver's style is determined.

While only one vehicle 102 is shown, the sensor data detected by multiple vehicles may be considered when determining the driver's style. In these embodiments, the driver 104 may be detected by the vehicle 102 using authentication credentials entered by the driver 104 or automatically detected using biometric data, such as facial recognition or fingerprint recognition, for example.

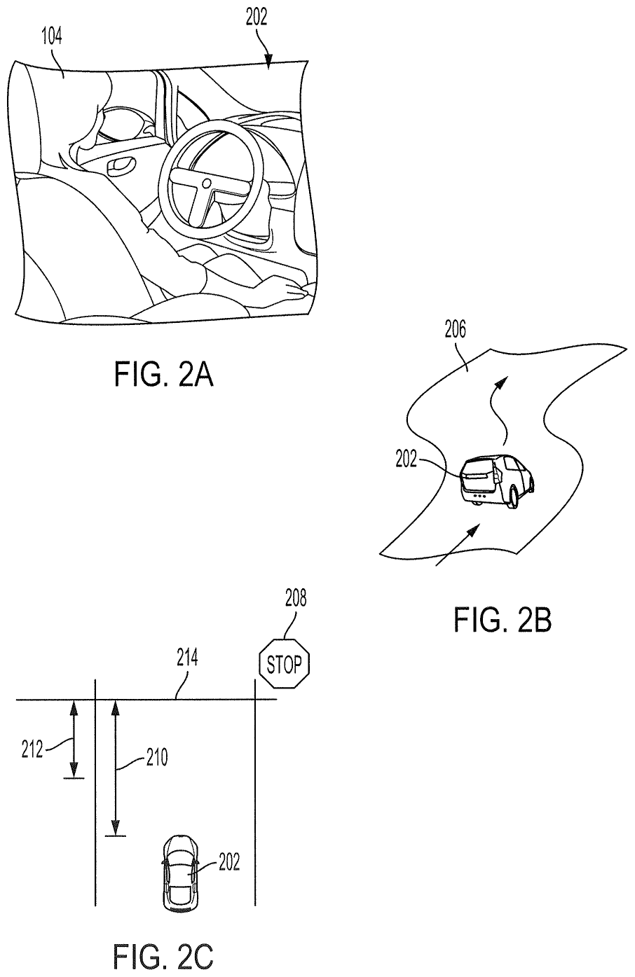

FIG. 2A illustrates the driver 104 in a vehicle 202. The vehicle 202 may be the same vehicle 102 of FIGS. 1A-1C that was driven in a non-autonomous mode, or the vehicle 202 may be one or more other vehicles that are capable of being driven in an autonomous mode.

Using the systems and methods described herein, the vehicle 202 adapts the autonomous driving of the vehicle 202 to resemble that of the driver 104. The driving style of the driver 104 may be detected while the driver 104 drove the vehicle 102 in a non-autonomous mode.

FIG. 2B illustrates the vehicle 202 operating based on the driver's style detected in FIG. 1B, and in other similar situations. For example, a default autonomous operation of the vehicle 202 may involve the vehicle 202 driving on the curved road 206 at moderate aggressiveness for steering and acceleration. However, using the driver's style, the autonomous operation of the vehicle 202 becomes more aggressive in steering and acceleration when the weather is clear and when the vehicle is driven in the daytime. In this way, the driver 104 has a similar experience in vehicle 202 driven autonomously as would be experienced in vehicle 102 that is driven by the driver 104.

FIG. 2C illustrates the vehicle 202 operating based on the driver's style detected in FIG. 1C, and in other similar situations. For example, a default autonomous operation of the vehicle 202 may involve the vehicle 202 beginning to brake at a default distance 212 before the stop line 214 as the vehicle 202 approaches the stop sign 208. However, using the driver's style, the autonomous operation of the vehicle 202 is adjusted to begin braking at the distance 210 away from the stop line 214 as the vehicle 202 approaches the stop sign 208. In this way, the driver 104 has a similar experience in vehicle 202 driven autonomously as would be experienced in vehicle 102 that is driven by the driver 104.

The exemplary scenarios illustrated in FIGS. 1B-1C and 2B-2C are merely illustrative and not limiting, and other situations may be possible where the driving style of the driver 104 is detected and applied by an autonomous vehicle.

In some embodiments, driving behavior of the driver 104 may be identified as being unsafe and/or illegal. For example, when the driver 104 drifts in and out of the driver's lane or when the driver 104 drives in a direction that is opposite of traffic flow, the vehicle 102 may identify this driving behavior as being unsafe and/or illegal. These unsafe and/or illegal driving behaviors may be flagged and may not factor into the driving style implemented by the vehicle 202 that is operated autonomously.

In some embodiments, when the vehicle 102 is a vehicle with manual transmission, the gear changing behavior may be included in the driving style to be implemented by the vehicle 202 that is operated autonomously.

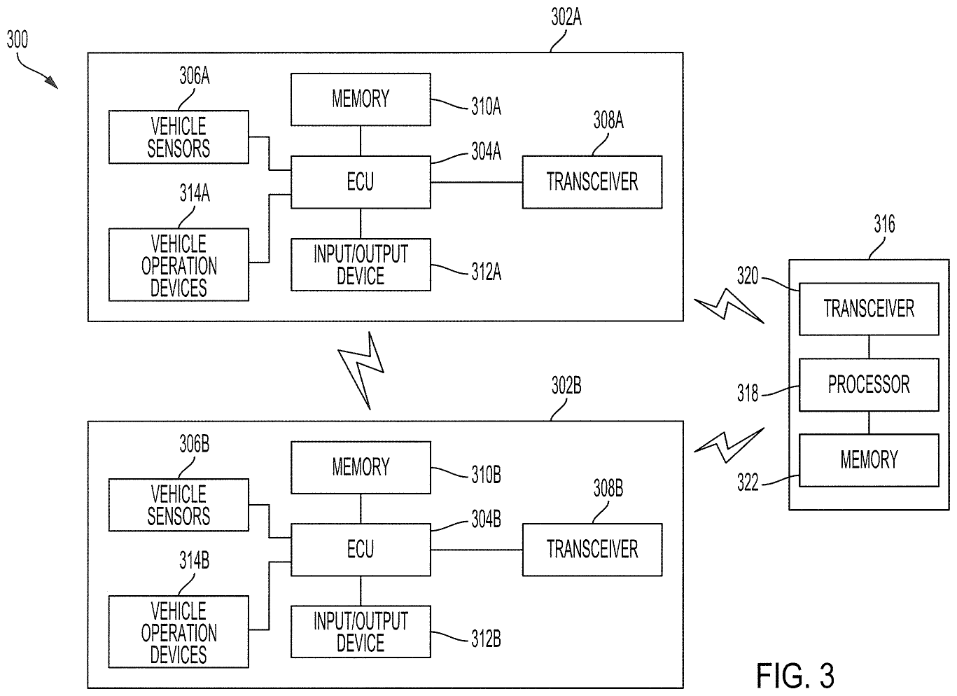

FIG. 3 illustrates an exemplary driver driving style detection and application system, according to various embodiments of the invention. The system 300 includes a first vehicle 302A, a second vehicle 302B, and a remote data server 316. Components having a letter suffix may be referred to collectively or individually by the number before the letter suffix. For example, vehicle 302 may refer to the first vehicle 302A and the second vehicle 302B collectively or may refer to either the first vehicle 302A or the second vehicle 302B individually. The vehicles 302 may be similar to any of the vehicles described herein, such as vehicle 102 or vehicle 202.

The vehicle 302 may have an automatic or manual transmission. The vehicle 302 is a conveyance capable of transporting a person, an object, or a permanently or temporarily affixed apparatus. The vehicle 302 may be a self-propelled wheeled conveyance, such as a car, a sports utility vehicle, a truck, a bus, a van or other motor or battery driven vehicle. For example, the vehicle 302 may be an electric vehicle, a hybrid vehicle, a plug-in hybrid vehicle, a fuel cell vehicle, or any other type of vehicle that includes a motor/generator. Other examples of vehicles include bicycles, trains, planes, or boats, and any other form of conveyance that is capable of transportation.

The vehicle 302 may be capable of non-autonomous operation or semi-autonomous operation or autonomous operation. That is, the vehicle 302 may be driven by a human driver or may be capable of self-maneuvering and navigating without human input. A vehicle operating semi-autonomously or autonomously may use one or more sensors and/or a navigation unit to drive autonomously.

In some embodiments, the first vehicle 302A is capable of being driven autonomously or non-autonomously and the second vehicle 302B is also capable of being driven autonomously or non-autonomously. In some embodiments, the first vehicle 302A is capable of being driven autonomously or non-autonomously and the second vehicle 302B is only capable of being driven autonomously. In some embodiments, the first vehicle 302A is only capable of being driven non-autonomously and the second vehicle 302B is capable of being driven autonomously or non-autonomously. In some embodiments, the first vehicle 302A is only capable of being driven non-autonomously and the second vehicle 302B is only capable of being driven autonomously.

The vehicle 302 includes an ECU 304 (e.g., ECU 304A and 304B) connected to a transceiver 308 (e.g., 308A and 308B), input/output device 312 (e.g., 312A and 312B), a memory 310 (e.g., 310A and 310B), vehicle sensors 306 (e.g., 306A and 306B), and vehicle operations devices 314 (e.g., 314A and 314B). The ECU 304 may be one or more ECUs, appropriately programmed, to control one or more operations of the vehicle. The one or more ECUs 304 may be implemented as a single ECU or in multiple ECUs. The ECU 304 may be electrically coupled to some or all of the components of the vehicle. In some embodiments, the ECU 304 is a central ECU configured to control one or more operations of the entire vehicle. In some embodiments, the ECU 304 is multiple ECUs located within the vehicle and each configured to control one or more local operations of the vehicle. In some embodiments, the ECU 304 is one or more computer processors or controllers configured to execute instructions stored in a non-transitory memory 310. All of the elements of the vehicle 302 may be connected via a communications bus.

The vehicle 302 may also have an infotainment unit, which has an input/output device 312 (e.g., a touchscreen display). The input/output device 312 may also display whether the driver driving style is being detected and/or whether the driver driving style is being used. The input/output device 312 may also display a map with turn-by-turn navigation directions to a destination. The input/output device 312 may also be used to receive, from the user, adjustments to the driving style. For example, when the user believes that the detected braking distance in the driver driving style is too long, the user may use the input/output device 312 to reduce the braking distance.

The driver driving style for any aspect (e.g., steering style) may be displayed as a set of numbers (e.g., 1, 2, 3, 4, 5) with an explanation of one side being more aggressive and the other side being less aggressive (e.g., 1 is less aggressive and 5 is more aggressive) and the driver may indicate, using the input/output device 312, a number corresponding to the driver's desired level of aggressiveness. The driver driving style may be displayed as a horizontal line with an explanation of one side being more aggressive and the other side being less aggressive (e.g., left is less aggressive and right is more aggressive) and the driver may indicate, using the input/output device 312, any point on the line corresponding to the driver's desired level of aggressiveness.

As described herein, the vehicle sensors 306 are configured to detect sensor data associated with various vehicle components (e.g., steering, braking, acceleration). The vehicle sensors 306 may include a steering sensor associated with the steering wheel and configured to detect steering data. The steering data may indicate a direction in which the steering wheel was turned and a speed by which the steering wheel was turned. The steering data may be analyzed by the ECU 304 along with other data (e.g., map data, vehicle speed data, braking data, acceleration data) to determine a steering style associated with the driver.

In some embodiments, the sensor data also includes transmission data associated with gear shifting when the vehicle being driven by the driver has a manual transmission. The transmission data may include RPMs at which the driver typically shifts gears and/or gear preferences of the driver in various situations.

The vehicle sensors 306 may also include a braking sensor associated with the brake pedal and configured to detect braking data. The braking data may indicate a degree to which the brake pedal was engaged and a swiftness with which the brake pedal was engaged. The braking data may be analyzed by the ECU 304 along with other data (e.g., map data, vehicle speed data, steering data, acceleration data, transmission data) to determine a braking style associated with the driver.

The vehicle sensors 306 may also include an acceleration sensor associated with the accelerator pedal and configured to detect acceleration data. The acceleration data may indicate a degree to which the accelerator pedal was engaged and a swiftness with which the accelerator pedal was engaged. The acceleration data may be analyzed by the ECU 304 along with other data (e.g., map data, vehicle speed data, steering data, braking data) to determine an acceleration style associated with the driver.

The vehicle sensors 306 may include a location sensor configured to determine location data. The ECU 304 may use the location data along with map data stored in memory 310 to determine a location of the vehicle. In other embodiments, the location sensor has access to the map data and may determine the location of the vehicle and provide the location of the vehicle to the ECU 304. The location sensor may be a GPS unit, a GLONASS system device, a Galileo system device, or any other global location detection device.

The vehicle sensors 306 may include a transmission sensor configured to determine transmission data. The ECU 304 may use the transmission data to determine vehicle conditions when gears were shifted and what situations which gear was used in. The transmission data may be analyzed by the ECU 304 along with other data (e.g., map data, vehicle speed data, steering data, braking data, acceleration data) to determine a transmission style associated with the driver.

The vehicle 302 may have vehicle operations devices 314 including multiple vehicle components each controlling one or more aspects of the vehicle 302. The vehicle operations devices 314 include a steering device (e.g., a steering wheel and a steering column), a braking device (e.g., a brake pedal and brake pads), an acceleration device (e.g., an accelerator pedal and a throttle), and a transmission device (e.g., a gear shift knob and a clutch pedal). Any other systems of the vehicle 302 may be adjusted based on the driver's driving style, and the systems and devices discussed herein are illustrative and non-limiting.

The memory 310 is connected to the ECU 304 and may be connected to any other component of the vehicle. The memory 310 is configured to store any data described herein, such as the vehicle sensor data, the map data, the driver driving style data, data received from any other sensors, and any data received from the remote data server 316 via the transceiver 308.

The vehicle 302 may be coupled to a network. The network, such as a local area network (LAN), a wide area network (WAN), a cellular network, a digital short-range communication (DSRC), LORA (Long Range), the Internet, or any other type of interconnectivity or combinations thereof, connects the vehicle 302 to a remote data server 316.

The transceiver 308 may include a communication port or channel, such as one or more of a Wi-Fi unit, a Bluetooth® unit, a Radio Frequency Identification (RFID) tag or reader, a DSRC unit, a LORA unit, or a cellular network unit for accessing a cellular network (such as 3G, 4G, or 5G) or any other wireless technology. The transceiver 308 may transmit data to and receive data from devices and systems not physically connected to the vehicle. For example, the ECU 304 may communicate with the remote data server 316. Furthermore, the transceiver 308 may access the network, to which the remote data server 316 is also connected.

In some embodiments, the ECU 304 determines the driver driving style data based on the vehicle sensor data. In other embodiments, the processor 318 of a remote data server 316 determines the driver driving style data based on the vehicle sensor data received from the vehicle 302.

The vehicle sensor data may be communicated from the vehicle 302 to the remote data server 316 via the transceiver 308 of the vehicle 302 and the transceiver 320 of the remote data server 316. The remote data server 316 includes a processor 318, a transceiver 320, and a memory 322, all connected to each other via a communications bus. The processor 318 (and any processors described herein) may be one or more computer processors configured to execute instructions stored on a non-transitory memory.

The memory 322 may be a non-transitory memory configured to store vehicle sensor data of a plurality of vehicles 302 and driver driving style data of a plurality of drivers. The driver driving style data may be indexed by a user identifier associated with the driver, and the user identifier may be associated with vehicle sensor data when the vehicle sensor data is communicated from the vehicle 302 to the remote data server 316. The memory 322 may sort the data in any way that increases the processor's ability to efficiently access the data. The transceiver 320 may be configured to transmit and receive data, similar to the transceiver 308.

Once the driver driving style data has been determined, the driver driving style data may be used by one or more vehicles driven autonomously when the driver is an occupant. For example, the first vehicle 302A may be driven by the driver non-autonomously. Once the driver driving style data has been determined, either by the ECU 304A or the processor 318 of the remote data server 316, the first vehicle 302A may use the determined driving style data associated with the driver when operating autonomously. The first vehicle 302A may adjust its default autonomous operation settings using the driver driving style data to adapt the autonomous operation to the particular driver.

Further, a second vehicle 302B may receive the driver driving style data, either from the remote data server 316 or the first vehicle 302A, and the second vehicle 302B may use the determined driving style data associated with the driver when operating autonomously. The second vehicle 302B may adjust its default autonomous operation settings using the driver driving style data to adapt the autonomous operation to the particular driver.

The driver driving style may be defined by driver driving style data. The driver driving style data may include driver steering style data, driver braking style data, driver transmission style, and/or driver acceleration style data, for example. The driver steering style data may be determined based on the steering data detected by the steering sensor. The driver braking style data may be determined based on the braking data detected by the braking sensor. The driver acceleration data may be determined based on the acceleration data detected by the acceleration sensor. The driver transmission style may be determined based on the transmission data detected by the transmission sensor. As described herein, one or more processors (or ECUs) may automatically analyze the steering data, the braking data, the transmission data, and/or the acceleration data to determine the driver steering style data, the driver braking style data, and/or the driver acceleration style data. The one or more processors may classify each data point of the steering data, the braking data, the transmission data, and/or the acceleration data and may determine trends based on the classification of the driver driving style data.

As described herein, some of the sensor data may not be used in determining the driver driving style, as the sensor data may be associated with driving behavior that is unsafe and/or illegal. For example, when the sensor data detects that the driver is driving in a direction that is opposite the flow of traffic, this sensor data may be flagged as being associated with unsafe and/or illegal driving behavior and may be deleted or not considered in determining the driver driving style. In another example, when the processor identifies that the driver has a trend that is unsafe and/or illegal, such as drifting in and out of lanes without use of a lane change signal, these trends may be flagged as being associated with unsafe and/or illegal driving behavior and may not be considered in determining the driver driving style. The memory 322 or memory 310 may store regulation data associated with driving laws and regulations and best practices, and the corresponding processor or ECU may use the regulation data to determine whether a driving maneuver or behavior is unsafe and/or illegal.

While only two vehicles 302A-302B are shown, any number of vehicles may be used. Likewise, while only one remote data server 316 is shown, any number of remote data servers in communication with each other may be used. Multiple remote data servers may be used to increase the memory capacity of the data being stored across the remote data servers, or to increase the computing efficiency of the remote data servers by distributing the computing load across the multiple remote data servers. Multiple vehicles or sensors may be used to increase the robustness of sensor data. Multiple remote data servers may be interconnected using any type of network, or the Internet.

As used herein, a “unit” may refer to hardware components, such as one or more computer processors, controllers, or computing devices configured to execute instructions stored in a non-transitory memory.

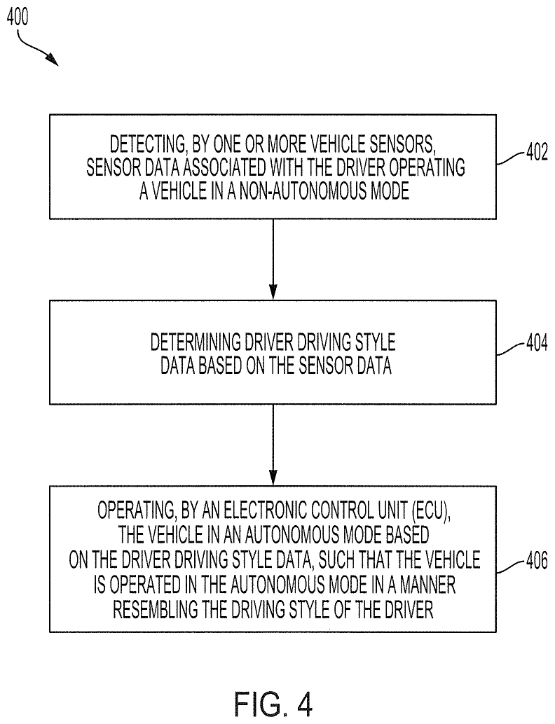

FIG. 4 illustrates a flow diagram of a process 400 performed by the driver driving style detection and application system, according to various embodiments of the invention.

One or more vehicle sensors (e.g., vehicle sensors 306) detect sensor data associated with the driver operating a vehicle (e.g., vehicle 302A) in a non-autonomous mode (step 402). The vehicle sensors may include a steering sensor configured to detect steering data, a brake sensor configured to detect braking data, a transmission sensor configured to detect transmission data, and/or an acceleration sensor configured to detect acceleration data. The vehicle sensors may also include a location sensor configured to detect location data. The vehicle may also receive environment data (e.g., weather data, time of day data, day of week data, elevation data) from a third-party server via a transceiver (e.g., transceiver 308).

Driver driving style data is determined based on the sensor data (step 404). The environment data may also be used to determine the driver driving style data. The driver driving style data may indicate how the driver has previously driven in various locations and conditions. In some embodiments, the driver driving style data is not determined unless a threshold sensor data count has been exceeded, to ensure a sufficient sample size has been reached.

In some embodiments, an electronic control unit (ECU) (e.g., ECU 304) of the vehicle determines the driver driving style data. In some embodiments, a processor (e.g., processor 318) of a remote data server (e.g., remote data server 316) determines the driver driving style data. In these embodiments, the transceiver of the vehicle communicates the sensor data to a transceiver (e.g., transceiver 320) of the remote data server. When the driver driving style data has been determined, the driver driving style data may be communicated to the vehicle or other vehicles (e.g., vehicle 302B) which may be driven in an autonomous mode.

An ECU operates the vehicle in an autonomous mode based on the driver driving style data, such that the vehicle is operated in the autonomous mode in a manner resembling the driving style of the driver (step 406). As described herein, a first vehicle (e.g., 302A) may be driven non-autonomously and the determined driver driving style data may be used by the first vehicle when operated in an autonomous mode. Also as described herein, the first vehicle may be driven non-autonomously and the determined driver driving style data may be used by a second vehicle (e.g., 302B) operated in an autonomous mode. Also as described herein, multiple vehicles (and multiple types of vehicles) may be driven by the driver non-autonomously, and the sensor data from these multiple vehicles (and multiple types of vehicles) may be communicated to the remote data server which determines the driver driving style data, which is used by a vehicle driven autonomously.

The vehicle which operates autonomously based on the driver driving style data may have default autonomous operation settings of one or more respective vehicle operations devices. These default autonomous operation settings may be adjusted by the ECU of the vehicle to reflect the driver driving style indicated in the driver driving style data.

Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for automatically detecting and applying a driving style of a driver, the system comprising:
one or more vehicle sensors configured to detect sensor data associated with the driver operating a vehicle in a non-autonomous mode; and
an electronic control unit (ECU) of the vehicle connected to the one or more vehicle sensors and configured to operate the vehicle in an autonomous mode based on driver driving style data determined based on the detected sensor data, such that the vehicle is operated in the autonomous mode in a manner resembling the driving style of the driver.

2. The system of claim 1, wherein the sensor data includes at least one of steering data, braking data, acceleration data, or transmission data, and
wherein the driver driving style data includes at least one of driver steering style data, driver braking style data, driver acceleration style data, or driver transmission style data.

3. The system of claim 1, wherein the ECU is further configured to determine the driver driving style data based on the detected sensor data.

4. The system of claim 1, further comprising:
a processor of a remote data server configured to determine the driver driving style data based on the sensor data;
a transceiver of the remote data server configured to communicate the driver driving style data to the vehicle; and
a transceiver of the vehicle configured to communicate the sensor data to the remote data server and receive the driver driving style data from the remote data server.

5. The system of claim 1, wherein the ECU operates the vehicle in the autonomous mode based on the driver driving style data by adjusting one or more default autonomous operation settings of one or more respective vehicle operations devices based on the driver driving style data.

6. The system of claim 1, further comprising an input/output device configured to receive an indication from the driver adjusting the operation of the vehicle in the autonomous mode.

7. The system of claim 1, wherein the driver driving style data is further determined based on sensor data from one or more other vehicles driven by the driver.

8. A system for automatically detecting and applying a driving style of a driver, the system comprising:
one or more vehicle sensors of a first vehicle configured to detect sensor data associated with the driver operating the first vehicle in a non-autonomous mode; and
an electronic control unit (ECU) of a second vehicle configured to operate the second vehicle in an autonomous mode based on driver driving style data determined based on the detected sensor data, such that the second vehicle is operated in the autonomous mode in a manner resembling the driving style of the driver operating the first vehicle.

9. The system of claim 8, wherein the sensor data includes at least one of steering data, braking data, acceleration data, or transmission data, and
wherein the driver driving style data includes at least one of driver steering style data, driver braking style data, driver acceleration style data, or driver transmission style data.

10. The system of claim 8, further comprising an ECU of the first vehicle connected to the one or more vehicle sensors of the first vehicle and configured to determine the driver driving style data based on the detected sensor data.

11. The system of claim 8, further comprising:
a processor of a remote data server configured to determine the driver driving style data based on the sensor data;
a transceiver of the remote data server configured to communicate the driver driving style data to the second vehicle;
a transceiver of the first vehicle configured to communicate the sensor data to the remote data server; and
a transceiver of the second vehicle configured to receive the driver driving style data from the remote data server.

12. The system of claim 8, wherein the ECU of the second vehicle operates the second vehicle in the autonomous mode based on the driver driving style data by adjusting one or more default autonomous operation settings of one or more respective vehicle operations devices based on the driver driving style data.

13. The system of claim 8, further comprising an input/output device of the second vehicle configured to receive an indication from the driver adjusting the operation of the second vehicle in the autonomous mode.

14. The system of claim 8, wherein the driver driving style data is further determined based on sensor data from one or more other vehicles driven by the driver.

15. A method for automatically detecting and applying a driving style of a driver, the method comprising:
detecting, by one or more vehicle sensors, sensor data associated with the driver operating a vehicle in a non-autonomous mode;
determining driver driving style data based on the sensor data; and
operating, by an electronic control unit (ECU), the vehicle in an autonomous mode based on the driver driving style data, such that the vehicle is operated in the autonomous mode in a manner resembling the driving style of the driver.

16. The method of claim 15, wherein the sensor data includes at least one of steering data, braking data, acceleration data, or transmission data, and
wherein the driver driving style data includes at least one of driver steering style data, driver braking style data, driver acceleration style data, or driver transmission style data.

17. The method of claim 15, further comprising determining, by the ECU, the driver driving style data based on the detected sensor data.

18. The method of claim 15, further comprising:
communicating, by a transceiver of the vehicle, the sensor data to a remote data server;
determining, by a processor of the remote data server, the driver driving style data based on the sensor data; and
communicating, by a transceiver of the remote data server, the driver driving style data to the vehicle.

19. The method of claim 15, wherein the ECU operates the vehicle in the autonomous mode based on the driver driving style data by adjusting one or more default autonomous operation settings of one or more respective vehicle operations devices based on the driver driving style data.

20. The method of claim 15, wherein the driver driving style data is further determined based on sensor data from one or more other vehicles driven by the driver.
